(19) United States
(12) Patent Application Publication
(10) Pub. No.: US 2024/0211726 A1
(43) Pub. Date: Jun. 27, 2024

(54) ARTIFICIAL INTELLIGENCE SERVICE PROVIDING DEVICE, AND OPERATION METHOD THEREFOR

(71) Applicant: SAMSUNG ELECTRONICS CO., LTD., Suwon-si (KR)

(72) Inventors: Minjin SONG, Suwon-si (KR); Jongyoub Ryu, Suwon-si (KR); Elmurod Talipov, Suwon-si (KR); Keehwan Ka, Suwon-si (KR); Kyoungchoon Park, Suwon-si (KR); Jayoung Yang, Suwon-si (KR); Jeongwon Lee, Suwon-si (KR)

(73) Assignee: SAMSUNG ELECTRONICS CO., LTD., Suwon-si (KR)

(21) Appl. No.: 18/600,376

(22) Filed: Mar. 8, 2024

Related U.S. Application Data
(63) Continuation of application No. PCT/KR2022/011502, filed on Aug. 3, 2022.

(30) Foreign Application Priority Data
Sep. 10, 2021 (KR) 10-2021-0121180

(51) Int. Cl. G06N 3/04

(52) U.S. Cl. CPC G06N 3/04

(57) ABSTRACT

A method of providing, by a device, an artificial intelligence service, includes: identifying neural network requirements related to a purpose of the artificial intelligence service and an execution environment of the device; selecting at least one neural network model satisfying the neural network requirements, based on neural network model information about a plurality of preregistered neural network models; obtaining a neural network model for providing the artificial intelligence service, by using the at least one neural network model; and providing the artificial intelligence service through the obtained neural network model.

### CROSS-REFERENCE TO RELATED APPLICATIONS

This application is a Continuation Application of International Application No. PCT/KR2022/011502, filed on Aug. 3, 2022, which is based on and claims priority to Korean Patent Application No. 10-2021-0121180, filed on Sep. 10, 2021, in the Korean Intellectual Property Office, the disclosures of which are incorporated by reference herein in their entireties.

### BACKGROUND

### 1. Field

The disclosure relates to a device for providing an artificial intelligence (AI) service and an operating method thereof, and more particularly, to a device for providing an artificial intelligence service by using a neural network model constructed according to a purpose of the artificial intelligence service and an execution environment of the device, and an operating method thereof.

### 2. Description of Related Art

Recently, with the development of technology such as artificial intelligence (e.g., machine learning or deep learning), intelligent services for providing data-related information or data-related services by automatically recognizing data, such as voice, images, video, or text, have been used in various fields.

Unlike an existing rule-based smart system, an artificial intelligence system is a computer system for implementing human-level intelligence and allows a machine to learn, determine, and become more intelligent by itself. Because the artificial intelligence system may have a higher recognition rate and more accurately understand user tastes as it is used more, existing rule-based smart systems have been gradually replaced by deep learning-based artificial intelligence systems.

Artificial intelligence technology may include machine learning (e.g., deep learning) and elementary technologies using machine learning. Machine learning may be an algorithm technology for classifying/learning the characteristics of input data by itself, and the elementary technologies may be technologies for simulating human brain's functions such as recognition and determination by using a machine learning algorithm such as deep learning and may include technical fields such as linguistic understanding, visual understanding, reasoning/prediction, knowledge representation, and motion control.

A device may provide inference results about input data based on the execution environment thereof (e.g., the position or time at which the device is used) by using a neural network model suitable for the purpose of an artificial intelligence service. Here, the Input data' may be data such as images, video, or text sensed from the surrounding environment of the device.

An on-device artificial intelligence service that does not go through a server may perform inference on input data by using a neural network model included in a computing program or a service application installed in a device. In this case, the neural network model used for inference may be statically distributed and managed in the service application and may not be shared between a plurality of service applications installed in the device. Thus, when a suitable neural network model changes according to the execution environment of the device, the service application should also change according to the change in the neural network model.

### SUMMARY

According to an aspect of the disclosure, a method of providing, by a device, an artificial intelligence service, may include: identifying neural network requirements related to a purpose of the artificial intelligence service and an execution environment of the device; selecting at least one neural network model satisfying the neural network requirements, based on neural network model information about a plurality of preregistered neural network models; obtaining a neural network model for providing the artificial intelligence service, by using the at least one neural network model; and providing the artificial intelligence service through the obtained neural network model.

The method further may include: obtaining the neural network model information about the plurality of preregistered neural network models stored in at least one memory in the device or in an external server; and registering the plurality of preregistered neural network models by storing the neural network model information in the at least one memory.

The identifying the neural network requirements may include identifying the neural network requirements based on a recognition target object to be recognized by using the obtained neural network model, at a position and time at which the device provides the artificial intelligence service.

The identifying the neural network requirements may include identifying the neural network requirements based on at least one of execution environment information about the device, information about a recognition target object to be recognized according to the purpose of the artificial intelligence service, and hardware resource feature information about the device providing the artificial intelligence service.

The selecting the at least one neural network model may include selecting the at least one neural network model based on performance information including information about recognition accuracy and latency of each of the plurality of preregistered neural network models.

The method further may include downloading the plurality of preregistered neural network models from an external server or an external database and storing the plurality of neural network models in at least one memory of the device.

The providing of the artificial intelligence service through the obtained neural network model may include: obtaining image data by photographing a surrounding environment of the device; and recognizing an object corresponding to the purpose of the artificial intelligence service, by applying the image data to the obtained neural network model.

According to an aspect of the disclosure, a device for providing an artificial intelligence service, the device may include: at least one memory storing at least one instruction; and at least one processor configured to execute the at least one instruction. The at least one processor may be configured to execute the at least one instruction to: identify neural network requirements related to a purpose of the artificial intelligence service and an execution environment of the device; select, based on neural network model information about a plurality of preregistered neural network models, at least one neural network model satisfying the neural network requirements among the plurality of preregistered neural network models; obtain a neural network model for providing the artificial intelligence service, by using the at least one neural network model; and provide the artificial intelligence service through the obtained neural network model.

The device further may include a communication interface. The at least one processor may be further configured to execute the at least one instruction to: obtain the neural network model information from an external server by using the communication interface or obtain the neural network model information from the plurality of preregistered neural network models stored in a neural network model storage in the device; and register the plurality of preregistered neural network models by storing the neural network model information in the at least one memory.

The at least one processor may be further configured to execute the at least one instruction to identify the neural network requirements based on at least one of execution environment information about the device, information about a recognition target object to be recognized according to the purpose of the artificial intelligence service, and hardware resource feature information about the device providing the artificial intelligence service.

The at least one processor may be further configured to execute the at least one instruction to select the at least one neural network model based on performance information including information about recognition accuracy and latency of each of the plurality of preregistered neural network models.

The device further may include a communication interface. The at least one processor may be further configured to execute the at least one instruction to: control the communication interface to download the plurality of preregistered neural network models from an external server or an external database, and store the plurality of neural network models in the at least one memory.

The at least one processor may be further configured to execute the at least one instruction to: select a selected plurality of neural network models satisfying the neural network requirements, and construct the obtained neural network model by combining the selected plurality of neural network models in any one of a sequential structure, a parallel structure, or a hybrid structure that is a combination of the sequential structure and the parallel structure.

The device further may include: a camera. The at least one processor may be further configured to execute the at least one instruction to: obtain image data by photographing a surrounding environment thereof by using the camera, and recognize an object corresponding to the purpose of the artificial intelligence service, by applying the image data to the obtained neural network model.

According to an aspect of the disclosure, a computer program product may include a non-transitory computer-readable storage medium, wherein the computer-readable storage medium may include instructions for a method of providing, by a device, an artificial intelligence service. The method may include: identifying neural network requirements related to a purpose of the artificial intelligence service and an execution environment of the device; selecting at least one neural network model satisfying the neural network requirements, based on neural network model information about a plurality of preregistered neural network models; obtaining an obtained neural network model for providing the artificial intelligence service, by using the at least one neural network model; and providing the artificial intelligence service through the obtained neural network model.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram illustrating a partial configuration of a device according to the related art;

FIG. 1B is a block diagram illustrating a partial configuration of a device according to one or more embodiments of the present disclosure;

FIG. 2 is a block diagram illustrating components of a device according to one or more embodiments of the present disclosure;

FIG. 3 is a diagram for describing data flows between components included in a device according to one or more embodiments of the present disclosure;

FIG. 4 is a flowchart illustrating an operating method of a device, according to one or more embodiments of the present disclosure;

FIG. 5 is a diagram for describing an operation of constructing a neural network model by a device, according to one or more embodiments of the present disclosure;

FIG. 6 is a flowchart illustrating a method of registering a neural network model by a device, according to one or more embodiments of the present disclosure;

FIG. 7 is a diagram illustrating neural network model information obtained in the process of registering a neural network model by a device, according to one or more embodiments of the present disclosure;

FIG. 8A is a diagram illustrating a neural network model constructed in a single structure by a device, according to one or more embodiments of the present disclosure;

FIG. 8B is a diagram illustrating a neural network model constructed by sequentially combining a plurality of neural network models by a device, according to one or more embodiments of the present disclosure;

FIG. 8C is a diagram illustrating a neural network model constructed by combining a plurality of neural network models in a parallel structure by a device, according to one or more embodiments of the present disclosure;

FIG. 8D is a diagram illustrating a neural network model constructed by combining a plurality of neural network models in a parallel structure by a device, according to one or more embodiments of the present disclosure;

FIG. 8E is a diagram illustrating a neural network model constructed by combining a plurality of neural network models in a hybrid structure by a device, according to one or more embodiments of the present disclosure;

FIG. 9 is a flowchart illustrating a method of providing an artificial intelligence service by a device, according to one or more embodiments of the present disclosure;

FIG. 10 is a flowchart illustrating operations between a plurality of components in a device, according to one or more embodiments of the present disclosure; and

FIG. 11 is a flowchart illustrating operations of a device and a server, according to one or more embodiments of the present disclosure.

### DETAILED DESCRIPTION

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the present disclosure. Thus, the terms used herein should be understood not as simple names but based on the meanings of the terms and the overall description of the present disclosure.

As used herein, the singular forms “a,” “an,” and “the” may include the plural forms as well, unless the context clearly indicates otherwise. Unless otherwise defined, all terms (including technical or scientific terms) used herein may have the same meanings as commonly understood by those of ordinary skill in the art of the present disclosure.

Also, in the disclosure, singular expressions include plural expressions, unless defined obviously differently in the context. Further, in the disclosure, terms such as “have,” “may have,” “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Elements described as “modules” or “part” may be physically implemented by analog and/or digital circuits including one or more of a logic gate, an integrated circuit, a microprocessor, a microcontroller, a memory circuit, a passive electronic component, an active electronic component, and the like.

In addition, the expressions “at least one of A and B” and “at least one of A or B” should be interpreted to mean any one of “A” or” B” or “A and B.” As another example, “performing at least one of steps 1 and 2” or “performing at least one of steps 1 or 2” means the following three juxtaposition situations: (1) performing step 1; (2) performing step 2; (3) performing steps 1 and 2.

The expression “configured to (or set to)” used herein may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “a system configured to . . . ” may mean that the system is “capable of . . . ” along with other devices or components. For example, “a processor configured to (or set to) perform A, B, and C” may refer to a dedicated processor (e.g., an embedded processor) for performing a corresponding operation, or a general-purpose processor (e.g., a central processing unit (CPU) or an application processor) capable of performing a corresponding operation by executing one or more software programs stored in a memory.

Also, herein, when an element is referred to as being “connected” or “coupled” to another element, the element may be directly connected or coupled to the other element and may also be connected or coupled to the other element through one or more other intervening elements therebetween unless otherwise specified.

Herein, an ‘artificial intelligence (AI) service’ may refer to a function and/or operation of providing inference results about input data by a device by using artificial intelligence technology (e.g., artificial neural network (ANN), deep neural network, reinforcement learning, decision tree learning, or classification model). Herein, the ‘input data’ may include at least one of image data, sound signals, sensor detection data, data collected from the Internet, or any combination thereof.

In one or more embodiments of the present disclosure, the artificial intelligence service may be provided by a service application executed by a device.

Herein, the ‘service application’ may be software for providing a service according to the purpose of an artificial intelligence service. In one or more embodiments of the present disclosure, the service application may obtain inference results from input data by using a neural network model and perform one or more functions and/or operations according to the inference results. In one or more embodiments of the present disclosure, the service application may detect a triggering event (e.g., obtaining image data by using a camera, obtaining sensing data by scanning the surrounding environment thereof by using a sensor, or receiving a command) according to the execution environment thereof and obtain inference data by using a neural network model in response to the triggering event.

Hereinafter, embodiments of the present disclosure will be described in detail with reference to the accompanying drawings so that those of ordinary skill in the art may easily implement the present disclosure. However, the present disclosure may be embodied in many different forms and should not be construed as being limited to the embodiments set forth herein.

Hereinafter, embodiments of the present disclosure will be described in detail with reference to the accompanying drawings.

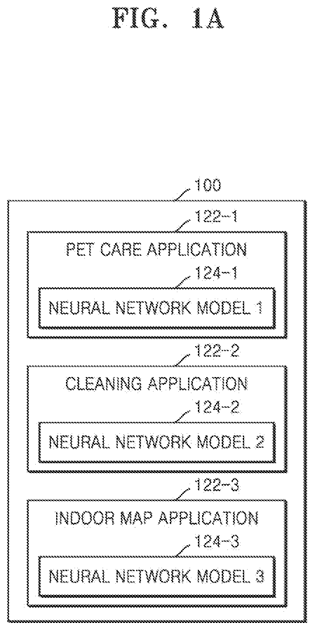

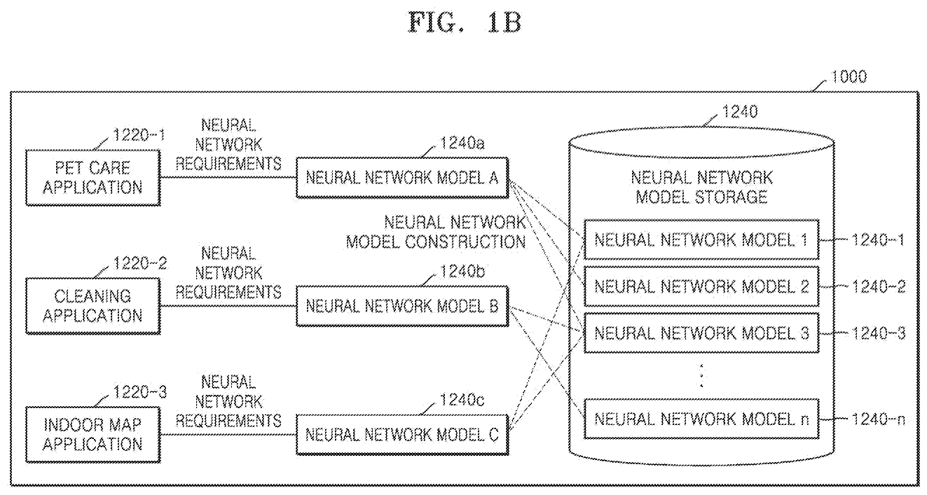

FIG. 1A is a block diagram illustrating a partial configuration of a general device 100.

Referring to FIG. 1A, the device 100 may include a plurality of service applications 122-1, 122-2, and 122-3. The plurality of service applications 122-1, 122-2, and 122-3 may be software programs installed in the device 100 and may be stored in a memory of the device 100.

The plurality of service applications 122-1, 122-2, and 122-3 may be software for obtaining inference results according to input data by using a neural network model and performing one or more functions and/or operations according to the inference results. The plurality of service applications 122-1, 122-2, and 122-3 may respectively include neural network models 124-1, 124-2, and 124-3. Referring to FIG. 1A, a first service application 122-1 may include a first neural network model 124-1, a second service application 122-2 may include a second neural network model 124-2, and a third service application 122-3 may include a third neural network model 124-3. FIG. 1A illustrates that one service application includes only one neural network model; however, the present disclosure is not limited thereto.

By executing a service application, the device 100 may perform a function and/or operation according to the inference results obtained by using a neural network model.

In the case of the general device 100 illustrated in FIG. 1A, the neural network models 124-1, 124-2, and 124-3 may be respectively statically distributed and managed in the plurality of service applications 122-1, 122-2, and 122-3, and the neural network models 124-1, 124-2, and 124-3 may not be shared between the plurality of service applications 122-1, 122-2, and 122-3. Thus, when a suitable neural network model changes according to the execution environment of the device 100, the service application should also change according to the change in the neural network model.

Also, in the case of an on-device method in which the device 100 provides an artificial intelligence service by using the neural network models 124-1, 124-2, and 124-3 stored therein such as in the memory, the neural network models 124-1, 124-2, and 124-3 may be lightweight models in which the capacity and function of the neural network model are restricted according to the hardware resources and operation ability of the processor and memory of the device 100. In the case of the general device 100 illustrated in FIG. 1A, because the neural network models 124-1, 124-2, and 124-3 are dependent on the plurality of service applications 122-1, 122-2, and 122-3, because two or more neural network models may not be used in combination, the accuracy of the inference results may be low and the processing time thereof may be long.

FIG. 1B is a block diagram illustrating a partial configuration of a device 1000 according to one or more embodiments of the present disclosure.

Referring to FIG. 1B, the device 1000 may include a plurality of service applications 1220-1, 1220-2, and 1220-3 and a neural network model storage 1240.

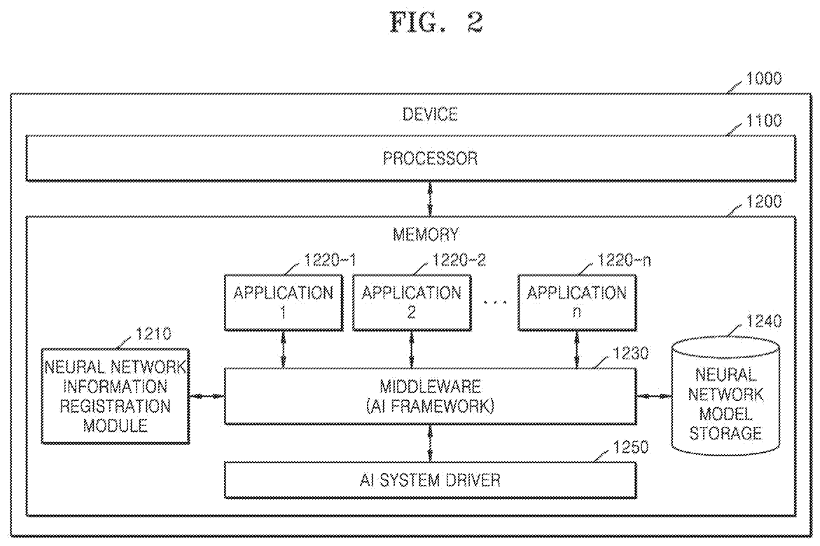

The plurality of service applications 1220-1, 1220-2, and 1220-3 may be software programs installed in the device 1000 and may be stored in a memory 1200 (see FIG. 2) of the device 1000. The plurality of service applications 1220-1, 1220-2, and 1220-3 may be software for obtaining inference results according to input data by using a neural network model and performing one or more functions and/or operations according to the inference results.

The neural network model storage 1240 may store a plurality of neural network models 1240-1, 1240-2, 1240-3, . . . , 1240-n. The plurality of neural network models 1240-1, 1240-2, 1240-3, . . . , 1240-n may be machine learning models trained according to the purpose of an artificial intelligence service such as image recognition, voice recognition, or sensor recognition. In one or more embodiments, each of the plurality of neural network models 1240-1, 1240-2, 1240-3, . . . , 1240-n may include at least one of a convolution neural network (CNN), a recurrent neural network (RNN), a support vector machine (SVM), linear regression, logistic regression, Naive Bayes, a random forest, a decision tree, or a k-nearest neighbor algorithm. Alternatively, each of the plurality of neural network models 1240-1, 1240-2, 1240-3, . . . , 1240-n may include any combination thereof or any other artificial intelligence models. For example, each of the plurality of neural network models 1240-1, 1240-2, 1240-3, . . . , 1240-n may include, for example, any one of Efficientdet-B3, Efficientnet-B0, YOLO-v4, RefineDet, or M2Det; however, the present disclosure is not limited thereto.

The device 1000 may identify neural network requirements of the plurality of service applications 1220-1, 1220-2, and 1220-3 and obtain neural network models 1240a, 1240b, and 1240c based on the neural network requirements. Here, the ‘neural network requirements’ may refer to requirements for constructing a neural network model in relation to the purpose of an artificial intelligence service provided by execution of the plurality of service applications 1220-1, 1220-2, and 1220-3 and the execution environment in which the device 1000 executes any one of the plurality of service applications 1220-1, 1220-2, and 1220-3. In one or more embodiments, the neural network requirements may be determined based on a recognition target object to be recognized by using a neural network model, at the position and time at which the device 1000 executes a service application to provide an artificial intelligence service. In another embodiment, the neural network requirements may be determined based on at least one of the execution environment (e.g., the execution position and time) of the device 1000, the recognition target object, or the hardware resources of the device 1000.

The ‘purpose of an artificial intelligence service’ may refer to the purpose of a service provided through a function and/or operation performed by the device 1000 by executing the plurality of service applications 1220-1, 1220-2, and 1220-3. In the embodiment illustrated in FIG. 1B, a first service application 1220-1 may be a pet care application, and the purpose of an artificial intelligence service provided by the first service application 1220-1 may be monitoring and managing the behaviors of companion animals such as dogs, cats, hamsters, and rabbits. A second service application 1220-2 may be a cleaning application, and the purpose of an artificial intelligence service provided by the second service application 1220-2 may be obstacle detection and obstacle avoidance for cleaning.

The device 1000 may select, based on the neural network requirements, at least one of the plurality of neural network models 1240-1, 1240-2, 1240-3, . . . , 1240-n stored in the neural network model storage 1240 and obtain a plurality of neural network models 1240a, 1240b, and 1240c by using the selected neural network model. In one or more embodiments, the device 1000 may select at least one neural network model satisfying the neural network requirements by using neural network model information. The neural network model information may include, for example, the identification information, performance information (capability), installation information, and evaluation information of the plurality of neural network models 1240-1, 1240-2, 1240-3, . . . , 1240-n. In the embodiment illustrated in FIG. 1B, the device 1000 may select a first neural network model 1240-1, a second neural network model 1240-2, and a third neural network model 1240-3 as neural network models satisfying the neural network requirements, based on the neural network model information of the first service application 1220-1. Also, the device 1000 may select, based on the neural network model information of the second service application 1220-2, the third neural network model 1240-3 and an n-th neural network model 1240-n as neural network models satisfying the neural network requirements and may select, based on the neural network model information of the third service application 1220-3, the first neural network model 1240-1 and the third neural network model 1240-3 as neural network models satisfying the neural network requirements.

The device 1000 may obtain the neural network models 1240a, 1240b, and 1240c for providing an artificial intelligence service by using the selected at least one neural network model. In one or more embodiments, the device 1000 may construct the neural network models 1240a, 1240b, and 1240c for providing an artificial intelligence service, by using the selected at least one neural network model in a single structure when the selected at least one neural network model is one neural network model, or by combining the selected at least one neural network model in a sequential structure or a parallel structure when the selected at least one neural network model is a plurality of neural network models. In the embodiment illustrated in FIG. 1B, a neural network model A 1240a may include a combination of the first neural network model 1240-1, the second neural network model 1240-2, and the third neural network model 1240-3. Likewise, a neural network model B 1240b may include a combination of the third neural network model 1240-3 and the n-th neural network model 1240-n, and a neural network model C 1240c may include a combination of the first neural network model 1240-1 and the third neural network model 1240-3.

By executing one of the plurality of service applications 1220-1, 1220-2, and 1220-3 according to the execution environment, the device 1000 may perform a function and/or operation according to the inference results using the neural network models 1240a, 1240b, and 1240c. For example, by executing the first service application 1220-1 that is a pet care application, the device 1000 may output a companion animal such as a dog, a cat, a hamster, or a rabbit as a recognition result from a surrounding environment image by using the neural network model A 1240a and perform a pet care-related function and/or operation according to the output result. As another example, by executing the second service application 1220-2 that is a cleaning application, the device 1000 may detect an obstacle in an indoor space from an image of the indoor space by using the neural network model B 1240b and perform a cleaning operation while avoiding the detected obstacle.

The present disclosure provides a device 1000 for providing an artificial intelligence service by using neural network models 1240a, 1240b, and 1240c constructed by selectively combining neural network models according to the purpose of an artificial intelligence service and the execution environment of the device 1000, and an operating method thereof.

The device 1000 according to the embodiment illustrated in FIG. 1B may identify neural network requirements of a plurality of service applications 1220-1, 1220-2, and 1220-3, select at least one neural network model based on the neural network requirements, and obtain neural network models 1240a, 1240b, and 1240c for providing an artificial intelligence service by using the selected at least one neural network model. In the embodiment illustrated in FIG. 1B, because the plurality of neural network models 1240-1, 1240-2, 1240-3, . . . , 1240-n stored in the neural network model storage 1240 may not be dependent on the service applications 1220-1, 1220-2, and 1220-3 and may be selectively combined based on the neural network requirements, the service application may not need to change even when the neural network model changes according to the execution environment of the device 1000.

Also, the plurality of neural network models 1240-1, 1240-2, 1240-3, . . . , 1240-n may be shared between the plurality of service applications 1220-1, 1220-2, and 1220-3 may be selectively replaced. Thus, even when the plurality of neural network models 1240-1, 1240-2, 1240-3, . . . , 1240-n are lightweight models according to the hardware resources and operation ability of the device 1000, the neural network models 1240a, 1240b, and 1240c constructed by combining at least one neural network model among the plurality of neural network models 1240-1, 1240-2, 1240-3, . . . , 1240-n may provide a technical effect of providing high inference accuracy and shortening the processing time required for inference.

FIG. 2 is a block diagram illustrating components of a device 1000 according to one or more embodiments of the present disclosure.

The device 1000 may provide an artificial intelligence service by executing service applications 1220-1 to 1220-n. The device 1000 may be, for example, any one of a smart phone, a tablet PC, a notebook computer (laptop computer), a digital camera, an e-book device, a digital broadcasting device, a personal digital assistant (PDA), a portable multimedia player (PMP), a navigation device, or a mobile terminal including an MP3 player; however, the present disclosure is not limited thereto.

In one or more embodiments, the device 1000 may include a home appliance. The device 1000 may be, for example, any one of a TV, a washing machine, a refrigerator, a kimchi refrigerator, an air conditioner, an air cleaner, a cleaner, a clothing care machine, an oven, a microwave oven, an induction cooker, an audio output device, or a smart home hub device. In one or more embodiments, the device 1000 may include a cleaning robot.

Referring to FIG. 2, the device 1000 may include a processor 1100 and memory 1200.

The processor 1100 may execute one or more instructions of the program stored in the memory 1200. The processor 1100 may include hardware components for performing arithmetic, logic, and input/output operations and signal processing. The processor 1100 may include, for example, at least one of a central processing unit (CPU), a microprocessor, a graphic processor (graphic processing unit (GPU)), application specific integrated circuits (ASICs), digital signal processors (DSPs), digital signal processing devices (DSPDs), programmable logic devices (PLDs), and field programmable gate arrays (FPGAs); however, the present disclosure is not limited thereto.

In FIG. 2, the processor 1100 is illustrated as one element; however, the present disclosure is not limited thereto. In one or more embodiments, the processor 1100 may include one or more processors.

In one or more embodiments, the processor 1100 may include an AI processor for performing artificial intelligence (AI) learning. In this case, the AI processor may perform inference using a neural network model of an artificial intelligence (AI) system. The AI processor may be manufactured in the form of a dedicated hardware chip for artificial intelligence (AI) (e.g., a neural processing unit (NPU)) or may be manufactured as a portion of an existing general-purpose processor (e.g., a CPU or an application processor) or a graphic processor (e.g., a GPU) and mounted on the device 1000.

The memory 1200 may include, for example, at least one type of storage medium among flash memory type, hard disk type, multimedia card micro type, card type memory (e.g., SD or XD memory), random access memory (RAM), static random access memory (SRAM), read-only memory (ROM), electronically erasable programmable read-only memory (EEPROM), programmable read-only memory (PROM), or optical disk.

The memory 1200 may store at least one of instructions, algorithms, data structures, and program codes readable by the processor 1100. The instructions, algorithms, data structures, and program codes stored in the memory 1200 may be implemented, for example, in programming or scripting languages such as C, C++, Java, and Assembler.

The memory 1200 may include a neural network information registration module 1210, a plurality of service applications 1220-1 to 1220-n, middleware 1230, a neural network model storage 1240, and an AI system driver 1250. The component included in the memory 1200 may refer to a unit for processing a function or operation performed by the processor 1100 and may be implemented as software such as instructions or program codes.

In the following embodiments, the processor 1100 may be implemented by executing the program instructions or program codes stored in the memory 1200.

The neural network information registration module 1210 may be a software module configured to register a plurality of neural network models in the middleware 1230 by providing neural network model information about the plurality of neural network models to the middleware 1230.

The neural network model may be a machine learning model trained according to the purpose of an artificial intelligence service such as image recognition, voice recognition, or sensor recognition. In one or more embodiments, the neural network model may include at least one of a convolution neural network (CNN), a recurrent neural network (RNN), a support vector machine (SVM), linear regression, logistic regression, Naive Bayes, a random forest, a decision tree, or a k-nearest neighbor algorithm. Alternatively, the neural network model may include any combination thereof or any other artificial intelligence models. The neural network model may be, for example, any one of Efficientdet-B3, Efficientnet-B0, YOLO-v4, RefineDet, or M2Det; however, the present disclosure is not limited thereto.

The processor 1100 may obtain neural network model information about a plurality of neural network models by executing instructions or program codes related to the neural network information registration module 1210 and register the obtained neural network model information in the middleware 1230. Here, ‘registration’ may refer to an operation of providing the neural network model information to the middleware 1230 and storing the same in a storage space accessible to the middleware 1230. The processor 1100 may execute a registration process one or more times while the device 1000 is being executed.

The neural network model information may include identification information, performance information, installation information, and evaluation information about the plurality of neural network models. The identification information may include the identifier (ID information) and version information of the neural network model. The performance information may refer to information about the function that may be performed by the neural network model, and may include information about neural network feature, neural network type, use environment, support system, input format, result format, accuracy, and latency. The installation information may be information about the position at which the neural network model is installed and may include information about the storage path and distribution method thereof. The evaluation information may include information about a performance evaluation result indicator about the function provided by the neural network model.

In one or more embodiments, the processor 1100 may obtain neural network model information from a plurality of neural network models stored in the neural network model storage 1240; however, the present disclosure is not limited thereto. In another embodiment, the device 1000 may further include a communication interface capable of transmitting/receiving data to/from an external server through a wired or wireless communication network, and the processor 1100 may receive neural network model information of a plurality of neural network models from the external server through the communication interface. The external server may be a server operated by the same entity as the manufacturer of the device 1000; however, the present disclosure is not limited thereto and the external server may be a public server operated by other companies for common use purposes. A plurality of neural network models provided by the public server may be public models permitted to be used by several entities.

The neural network model information may be explicitly provided as described above; however, the present disclosure is not limited thereto. In one or more embodiments, the neural network model information may be automatically generated.

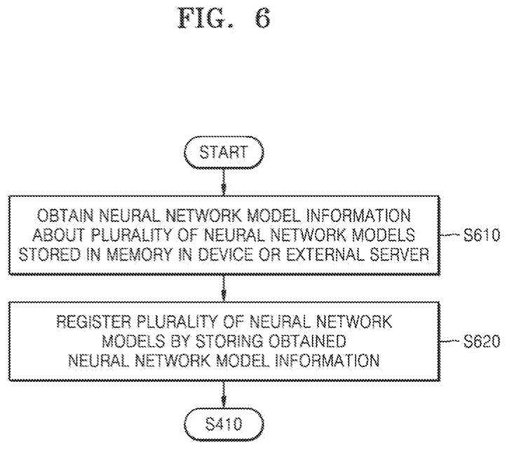

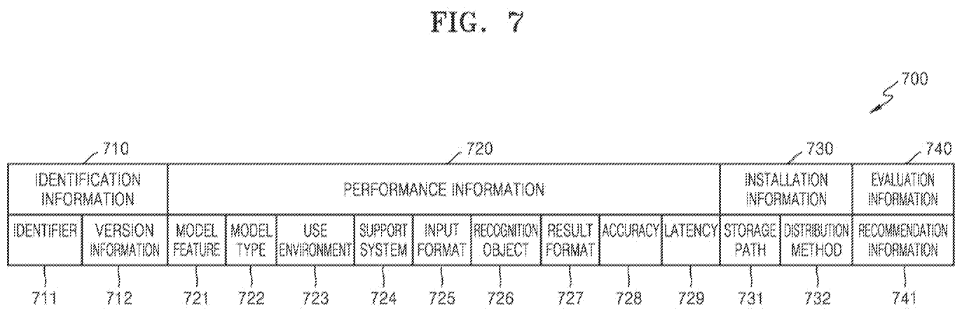

One or more embodiments in which the processor 1100 registers a plurality of neural network models by using the neural network information registration module 1210 will be described in detail with reference to FIGS. 6 and 7.

The plurality of service applications 1220-1 to 1220-n may be software for obtaining inference results according to input data by using a neural network model constructed by the middleware 1230 and performing one or more functions and/or operations according to the inference results. The plurality of service applications 1220-1 to 1220-n may provide functions according to different service purposes. For example, a first service application 1220-1 may be software for monitoring and managing the behaviors of companion animals such as dogs, cats, hamsters, or rabbits, and a second service application 1220-2 may be software for performing a cleaning operation by detecting and avoiding obstacles (e.g., wires, socks, toys, or mops lying on the floor).

The plurality of service applications 1220-1 to 1220-n may obtain information about the execution environment of the device 1000 and determine neural network requirements based on the execution environment and the purpose of an artificial intelligence service. In one or more embodiments, the device 1000 may include a sensor, and the processor 1100 may obtain information related to the execution environment of the device 1000 by using the sensor. For example, the processor 1100 may use the sensor to obtain not only information about the position and time at which the device 1000 is being executed, but also information about illuminance, temperature, or humidity. In one or more embodiments, the processor 1100 may obtain use environment information including not only the information obtained by using the sensor, but also at least one of information obtained from the Internet through a wired or wireless network, syntax information related to a system operation, user information, and input information. The plurality of service applications 1220-1 to 1220-n may determine neural network requirements based on not only the execution environment information and the purpose of an artificial intelligence service but also the hardware resources and operation ability of the device 1000. The ‘hardware resources’ may include hardware information about the operation and inference ability of the processor 1100 and the capacity of the memory 1200.

In one or more embodiments, the plurality of service applications 1220-1 to 1220-n may determine neural network requirements based on information about a reference value set for the accuracy and latency of the neural network model included in the neural network model information. For example, in order to obtain the expected inference performance and inference accuracy for the neural network model, the plurality of service applications 1220-1 to 1220-n may set a minimum reference value for the accuracy of the neural network model and a maximum reference time for the latency and determine neural network requirements based on the minimum reference value set for the accuracy and the maximum reference time set for the latency.

The plurality of service applications 1220-1 to 1220-n may provide the middleware 1230 with a neural network request signal for requesting a neural network model, together with the neural network requirements.

The middleware 1230 may be software for managing and controlling the selection and combination of neural network models and the execution of the plurality of service applications 1220-1 to 1220-n. The middleware 1230 may store and manage neural network model information and construct a neural network model for providing an artificial intelligence service by using the neural network model information. The neural network model information may be managed in a system storage space available in the middleware 1230.

By executing the instructions or program code related to the middleware 1230, the processor 1100 may select at least one neural network model among the plurality of neural network models stored in the neural network model storage 1240 and obtain a neural network model for providing an artificial intelligence service by using the selected at least one neural network model.

Based on the neural network model information about the plurality of neural network models registered in the middleware 1230, the processor 1100 may select at least one neural network model satisfying the service requirements provided by the plurality of service applications 1220-1 to 1220-n. In one or more embodiments, the processor 1100 may select at least one neural network model among the plurality of neural network models stored in the neural network model storage 1240, based on not only the execution environment information of the device 1000 and the purpose of the artificial intelligence service included in the neural network requirements but also the recognition accuracy and latency of the neural network model. In one or more embodiments, the processor 1100 may select at least one neural network model satisfying a minimum reference value set for the recognition accuracy and a maximum latency set for the latency included in the neural network requirements.

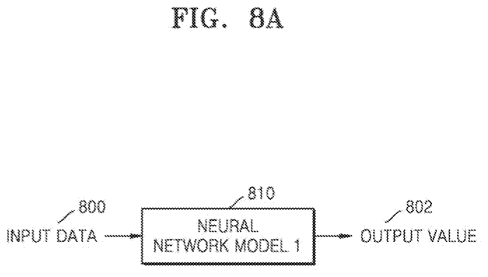

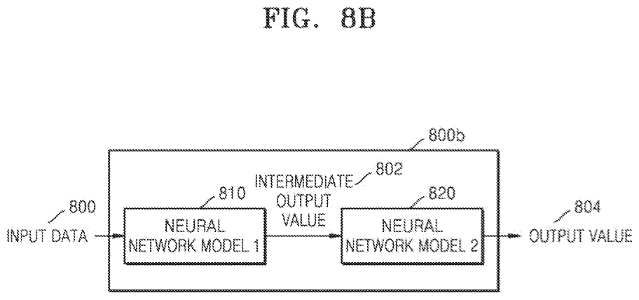

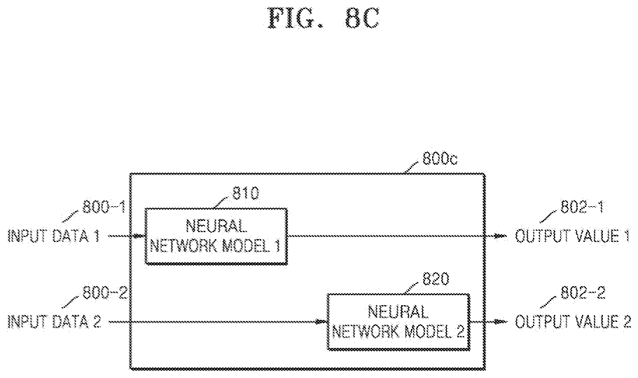

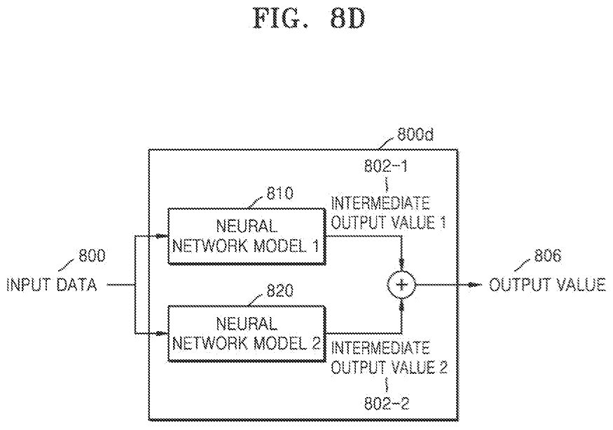

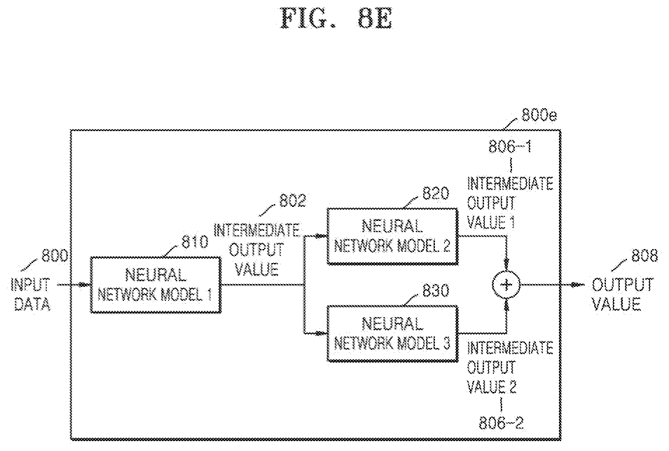

The processor 1100 may obtain a neural network model for providing an artificial intelligence service by using the selected at least one neural network model. In one or more embodiments, the processor 1100 may select only one neural network model, and in this case, a neural network model for providing an artificial intelligence service may be constructed in a single structure. In another embodiment, the processor 1100 may select a plurality of neural network models and combine the plurality of selected neural network models in at least one of a parallel structure, a sequential structure, and a hybrid structure to construct a neural network model for providing an artificial intelligence service. A particular embodiment in which the processor 1100 constructs a neural network model for providing an artificial intelligence service by using one neural network model in a single structure or by combining a plurality of neural network models will be described in detail with reference to FIGS. 8A to 8E.

The neural network model storage 1240 may be a storage that stores a plurality of neural network models. In one or more embodiments, the neural network model storage 1240 may include a nonvolatile memory. The nonvolatile memory may refer to a storage medium that may store and retain information even when power is not supplied thereto and may use the stored information again when power is supplied thereto. The nonvolatile memory may include, for example, a flash memory, a hard disk, a solid state drive (SSD), a multimedia card micro type memory, a card type memory (e.g., an SD or XD memory), a read only memory (ROM), a magnetic disk, or an optical disk.

In FIG. 2, the neural network model storage 1240 is illustrated as a component included in the memory 1200; however, the present disclosure is not limited thereto. In one or more embodiments, the neural network model storage 1240 may be included in the device 1000 as a separate component from the memory 1200 or may be implemented in the form of an external memory not included in the device 1000. However, the present disclosure is not limited thereto, and the neural network model storage 1240 may be implemented as a web-based storage medium connected through a wired or wireless communication network through a communication interface.

The processor 1100 may download a plurality of neural network models from an external server or an external database by using a communication interface and store the plurality of downloaded neural network models in the neural network model storage 1240. In one or more embodiments, the processor 1100 may download a plurality of neural network models at the run time when any one of the plurality of service applications 1220-1 to 1220-n is executed. However, the present disclosure is not limited thereto, and the processor 1100 may download a plurality of neural network models at the time when the device 1000 is turned on or at the time when a neural network request signal is received from the plurality of service applications 1220-1 to 1220-n.

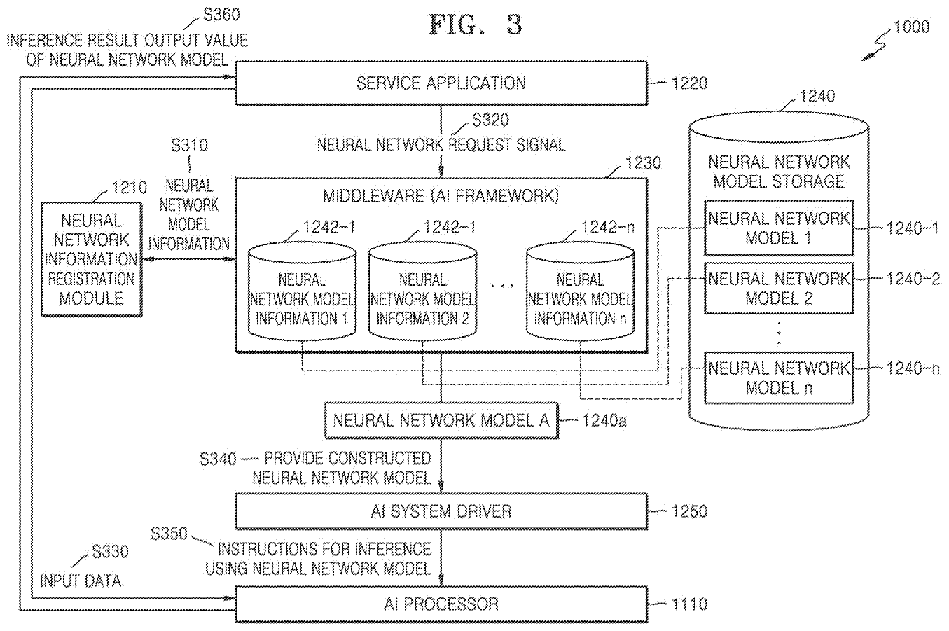

The AI system driver 1250 may be software that allows the neural network model configured to provide an artificial intelligence service to be executed by the processor 1100. In one or more embodiments, the processor 1100 may include an AI processor 1110 (see FIG. 3) that may perform inference using a neural network model, and the AI system driver 1250 may provide a neural network model to the AI processor 1110 such that the neural network model may be driven by the AI processor 1110.

The processor 1100 may provide an artificial intelligence service by using a neural network model. The processor 1100 may obtain an output value by applying input data to a neural network model and performing inference. The Input data' may include at least one of image data, sound signals, sensor detection data, data collected from the Internet, or any combination thereof. The input data may be, for example, image data about the surrounding environment obtained by photographing the surrounding environment by using a camera.

In one or more embodiments, the device 1000 may further include a camera for obtaining image data by photographing the surrounding environment. The processor 1100 may recognize an object from the image data by applying the image data of the surrounding environment obtained from the camera as input data to the neural network model and performing inference using the neural network model. The processor 1100 may use the recognized object to perform a function and/or operation according to the purpose of an artificial intelligence service. For example, by executing any one of the plurality of service applications 1220-1 to 1220-n, the processor 1100 may provide an artificial intelligence service such as a pet care service, a cleaning operation, air conditioner temperature control, or monitoring of the indoor air quality by an air cleaner.

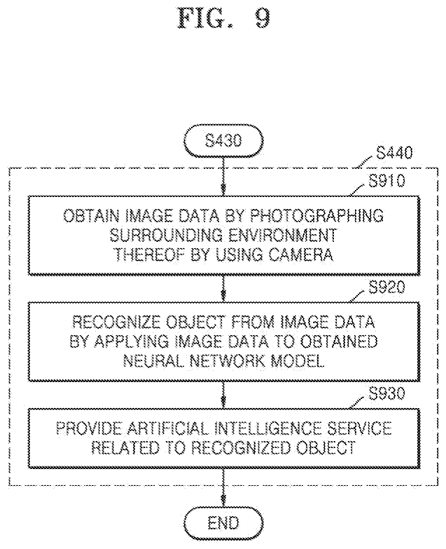

A particular embodiment in which the processor 1100 provides an artificial intelligence service by using a neural network model will be described in detail with reference to FIG. 9.

FIG. 3 is a diagram for describing data flows between components included in a device 1000 according to one or more embodiments of the present disclosure.

Referring to FIG. 3, the device 1000 may include an AI processor 1110, a neural network information registration module 1210, a service application 1220, middleware 1230, a neural network model storage 1240, and an AI system driver 1250. The neural network information registration module 1210, the service application 1220, the middleware 1230, the neural network model storage 1240, and the AI system driver 1250 illustrated in FIG. 3 may be respectively the same as the neural network information registration module 1210, the service application 1220, the middleware 1230, the neural network model storage 1240, and the AI system driver 1250 illustrated in FIG. 2, and thus, redundant descriptions of each component will be omitted for conciseness.

In operation S310, the neural network information registration module 1210 may provide neural network model information to the middleware 1230. In one or more embodiments, the neural network model information may include identification information, performance information, installation information, and evaluation information about a plurality of neural network models 1240-1 to 1240-n. The identification information may include the identifiers (ID information) and version information of the plurality of neural network models 1240-1 to 1240-n. The performance information may refer to information about the function that may be performed by the plurality of neural network models 1240-1 to 1240-n, and may include information about neural network feature, neural network type, use environment, support system, input format, result format, accuracy, and latency. The installation information may be information about the position at which the plurality of neural network models 1240-1 to 1240-n are installed and may include information about the storage path and distribution method thereof. The evaluation information may include information about performance evaluation result indicators about the functions provided by the plurality of neural network models 1240-1 to 1240-n.

The neural network information registration module 1210 may register the plurality of neural network models 1240-1 to 1240-n in the middleware 1230 by providing the neural network model information to the middleware 1230. The neural network information registration module 1210 may register the plurality of neural network models 1240-1 to 1240-n by providing the middleware 1230 with first neural network model information 1242-1 about the first neural network model 1240-1, second neural network model information 1242-2 about the second neural network model 1240-2, . . . , n-th neural network model information 1242-n about the n-th neural network model 1240-n stored in the neural network model storage 1240. The middleware 1230 may store the first neural network model information 1242-1 to the n-th neural network model information 1242-n.

In operation S320, the service application 1220 may transmit a neural network request signal to the middleware 1230. In one or more embodiments, the service application 1220 may transmit neural network requirements to the middleware 1230 together with the neural network request signal. The neural network requirements may be determined based on information about at least one of the execution environment of the device 1000 (e.g., information about the position and time at which the device 1000 executes the service application 1220), the purpose of the artificial intelligence service, and the hardware resource feature of the device 1000.

In response to the neural network request signal received from the service application 1220, the middleware 1230 may obtain a neural network model 1240a for providing an artificial intelligence service by selectively combining the plurality of neural network models 1240-1 to 1240-n. In one or more embodiments, the middleware 1230 may select at least one neural network model satisfying the neural network requirements by using the neural network model information 1242-1 to 1242-n about a plurality of preregistered neural network models 1240-1 to 1240-n and construct a neural network model 1240a for providing an artificial intelligence service by using or combining the selected at least one neural network model in a single structure. The function and/or operation of the middleware 1230 may be the same as those described above with reference to FIG. 2, and thus, redundant descriptions thereof will be omitted for conciseness.

In operation S330, the service application 1220 may provide input data to the AI processor 1110. In one or more embodiments, the service application 1220 may provide the input data obtained according to the purpose of an artificial intelligence service to the AI processor 1110. Here, the Input data' may include at least one of image data, sound signals, sensor detection data, data collected from the Internet, or any combination thereof. The input data may be, for example, image data about the surrounding environment obtained by photographing the surrounding environment by using a camera.

In operation S340, the middleware 1230 may provide the constructed neural network model 1240a to the AI system driver 1250. The AI system driver 1250 may convert the neural network model 1240a into program codes or instructions such that the neural network model 1240a may be executed by the AI processor 1110.

In operation S350, the AI system driver 1250 may provide instructions for performing inference using the neural network model 1240a to the AI processor 1110. In one or more embodiments, the AI processor 1110 may be a dedicated hardware chip for performing multiplication and addition operations included in the neural network model 1240a. The AI processor 1110 may include, for example, a neural processing unit (NPU). However, the present disclosure is not limited thereto, and the AI processor 1110 may be configured as a portion of an existing general-purpose processor (e.g., a CPU or an application processor) or a graphic processor (e.g., a GPU).

The AI processor 1110 may perform inference by executing instructions for driving the neural network model 1240a provided from the AI system driver 1250. The AI processor 1110 may perform inference by applying the input data received from the service application 1220 as an input to the neural network model 1240a and obtain an output value as a result of the inference. In one or more embodiments, the output value according to the inference result may be a label value about the type of an object recognized from the input data as a result of the inference using the neural network model.

In operation S360, the AI processor 1110 may provide the output value obtained as a result of the inference by the neural network model 1240a to the service application 1220.

By using the output value of the neural network model 1240a received from the AI processor 1110, the service application 1220 may obtain information about the recognized object from the input data and perform a function and/or operation related to the recognized object.

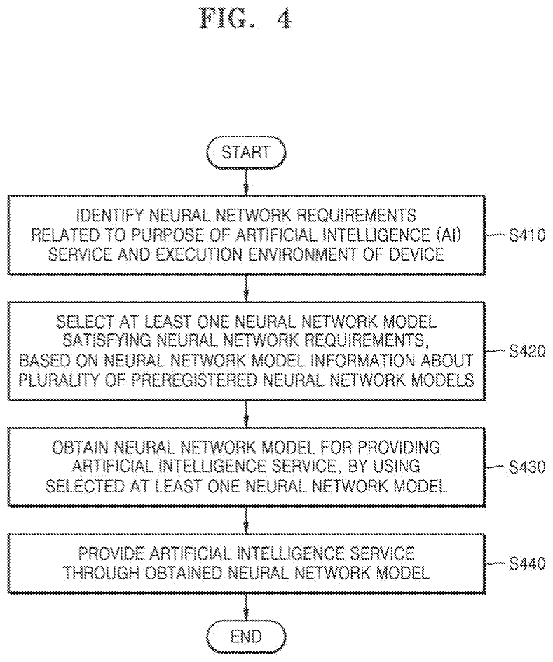

FIG. 4 is a flowchart illustrating an operating method of a device 1000 according to one or more embodiments of the present disclosure.

In operation S410, the device 1000 may identify neural network requirements related to the purpose of an artificial intelligence (AI) service and the execution environment of the device 1000. In one or more embodiments, the purpose of an artificial intelligence service may be determined by a service application. For example, when a first service application is pet care software for monitoring and managing the behavior of a companion animal such as a dog, cat, hamster, or rabbit, the purpose of an artificial intelligence service provided by the first service application may be to recognize a companion animal present in the surrounding environment. As another example, when a second service application is a cleaning application for controlling a cleaning robot to perform a cleaning operation, the purpose of an artificial intelligence service provided by the second service application may be to detect an obstacle (e.g., wires, socks, toys, or mops lying on the floor).

In one or more embodiments, the device 1000 may include a sensor and may obtain information related to the execution environment of the device 1000 by using the sensor. For example, the device 1000 may use the sensor to obtain not only information about the position and time at which the device 1000 is being executed, but also information about illuminance, temperature, or humidity. In one or more embodiments, by using a communication interface, the device 1000 may obtain at least one of information obtained from the Internet through a wired or wireless network, syntax information related to a system operation, user information, and input information.

The device 1000 may determine neural network requirements based on the purpose of an artificial intelligence service provided by a service application and the execution environment of the device 1000. In one or more embodiments, the purpose of the artificial intelligence service may be a recognition target object to be recognized by using a neural network model.

In another embodiment, the device 1000 may determine neural network requirements based on information about at least one of a recognition target object to be recognized according to the purpose of an artificial intelligence service, the execution environment of the device, and the hardware resource feature of the device 1000. The ‘hardware resource feature’ of the device 1000 may include hardware information about the operation and inference ability of the processor 1100 (see FIG. 2) and the capacity of the memory 1200 (see FIG. 2).

In operation S420, the device 1000 may select at least one neural network model satisfying the neural network requirements based on neural network model information about a plurality of preregistered neural network models. In one or more embodiments, the device 1000 may register a plurality of neural network models by storing neural network model information about each of the plurality of neural network models. In one or more embodiments, the neural network model information may include identification information, performance information, installation information, and evaluation information about the plurality of neural network models.

The device 1000 may select at least one neural network model among the plurality of neural network models stored in the neural network model storage 1240 (see FIG. 2), based on not only the execution environment information of the device 1000 and the purpose of the artificial intelligence service included in the neural network requirements but also the recognition accuracy and latency of the neural network model. In one or more embodiments, the device 1000 may select at least one neural network model satisfying a minimum reference value set for the recognition accuracy and a maximum latency set for the latency included in the neural network requirements.

In operation S430, the device 1000 may obtain a neural network model for providing an artificial intelligence service by using the selected at least one neural network model. In one or more embodiments, the device 1000 may select only one neural network model, and in this case, a neural network model for providing an artificial intelligence service may be constructed in a single structure. In another embodiment, the device 1000 may select a plurality of neural network models and combine the plurality of selected neural network models in at least one of a parallel structure, a sequential structure, and a hybrid structure to construct a neural network model for providing an artificial intelligence service.

In operation S440, the device 1000 may provide an artificial intelligence service by using the obtained neural network model. In one or more embodiments, the device 1000 may obtain image data by photographing the surrounding environment by using a camera. The device 1000 may recognize an object from the image data by applying the obtained image data as input data to the neural network model and performing inference using the neural network model. The device 1000 may provide an artificial intelligence service related to the recognized object.

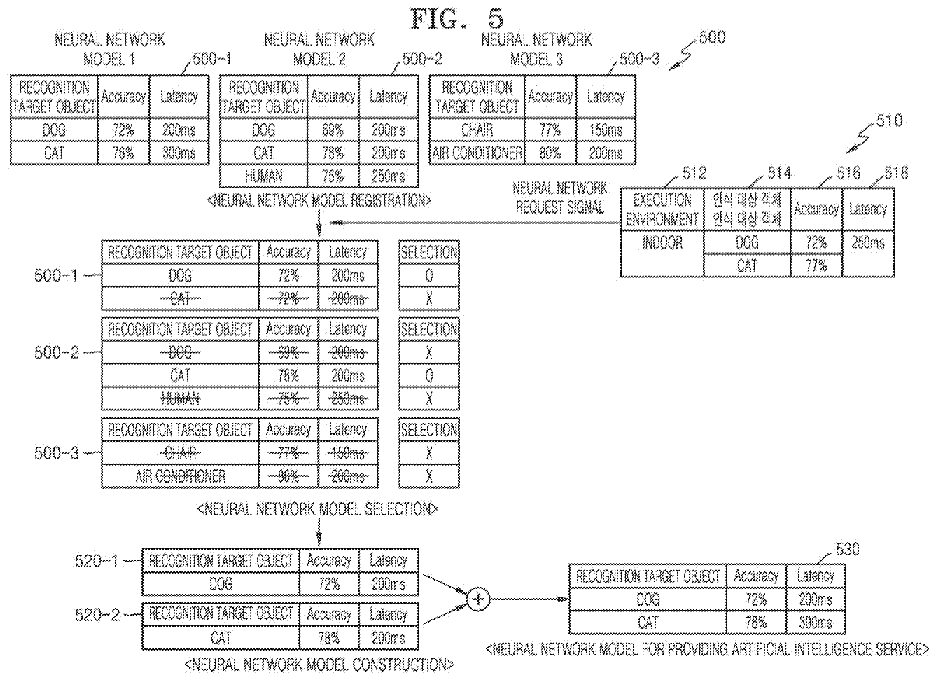

FIG. 5 is a diagram for describing an operation of constructing a neural network model 530 for providing an artificial intelligence (AI) service by a device 1000 according to one or more embodiments of the present disclosure.

Referring to FIG. 5, the device 1000 may register a plurality of neural network models 500 by storing neural network model information about the plurality of neural network models 500. The neural network model information may include identification information, performance information, installation information, and evaluation information about the plurality of neural network models 500. In the embodiment illustrated in FIG. 5, the neural network model information may include information about at least one of a recognition target object, accuracy, and latency according to the purpose of an artificial intelligence service provided by the plurality of neural network models 500.

The plurality of neural network models 500 may include a first neural network model 500-1, a second neural network model 500-2, and a third neural network model 500-3. Referring to the embodiment illustrated in FIG. 5, the first neural network model 500-1 may be a neural network model capable of recognizing animals such as dogs and cats. Referring to the neural network model information of the first neural network model 500-1, the recognition target objects may be a dog and a cat, the accuracy of recognizing a dog from the input data may be 72%, and the accuracy of recognizing a cat may be 76%. Also, the latency required for the first neural network model 500-1 to recognize a dog among the recognition target objects may be 200 ms, and the latency required to recognize a cat may be 300 ms. The second neural network model 500-2 may be an object recognition model capable of recognizing dogs, cats, and humans. Referring to the neural network model information of the second neural network model 500-2, the recognition target objects may be a dog, a cat, and a human, the accuracy of recognizing a dog may be 69%, the accuracy of recognizing a cat may be 78%, and the accuracy of recognizing a human is 75%. Also, the latency required for the second neural network model 500-2 to recognize a dog and a cat among the recognition target objects may be 200 ms, and the latency required to recognize a human may be 250 ms. The third neural network model 500-3 may be an object recognition model capable of recognizing objects such as chairs and air conditioners. Referring to the neural network model information of the third neural network model 500-3, the recognition target objects may be a chair and an air conditioner, the accuracy of recognizing a chair may be 77%, and the accuracy of recognizing an air conditioner may be 80%. Also, the latency required for the third neural network model 500-3 to recognize a chair among the recognition target objects may be 150 ms, and the latency required to recognize an air conditioner may be 200 ms.

The device 1000 may identify neural network requirements 510. The neural network requirements 510 may include requirement information about at least one of an execution environment 512, a recognition target object 514, accuracy 516, and latency 518. In the embodiment illustrated in FIG. 5, among the neural network requirements 510, the execution environment 512 may be ‘indoor’, the recognition target object 514 may be ‘dog’ and ‘cat’, the accuracy 516 may have a minimum reference value of ‘70%’ in the case of a dog’ and a minimum reference value of ‘77%’ in the case of a cat, and a maximum reference value of latency 518 may be 250 ms.

The device 1000 may select at least one neural network model satisfying the neural network requirements 510 based on the neural network model information of the plurality of neural network models 500. In the embodiment illustrated in FIG. 5, because the accuracy for a dog among the recognition target objects exceeds 70% that is the minimum reference value about the accuracy of the neural network requirements and the latency is less than 250 ms that is the maximum reference value, the first neural network model 500-1 may satisfy the neural network requirements. However, when the recognition target object is a cat, because the accuracy is 76% and is less than 77% that is the minimum reference value about the accuracy of the neural network requirements, the device 1000 may select only the case of the recognition target object being ‘dog’ excluding ‘cat’ from the recognition target objects in the first neural network model 500-1. As a result of the selection, the first neural network model 500-1 may be reconstructed as a first neural network model 520-1 including ‘dog’ as a recognition target object. Likewise, as for the second neural network model 500-2, the accuracy for a dog among the recognition target objects is less than 70% that is the minimum reference value about the accuracy of the neural network requirements. Also, because ‘human’ is not a recognition target object in the neural network requirements, the device 1000 may select only the case of the recognition target object being ‘cat’ excluding ‘dog’ and ‘human’ from the recognition target objects in the second neural network model 500-2. The second neural network model 500-2 may be reconstructed as a second neural network model 520-2 including only ‘cat’ as a recognition target object.

Because the recognition target objects are ‘chair’ and ‘air conditioner’, the third neural network model 500-3 may fail to satisfy the neural network requirements. Thus, the device 1000 may not select the third neural network model 500-3.

The device 1000 may obtain a neural network model for providing an artificial intelligence service by combining the selected at least one neural network model. In the embodiment illustrated in FIG. 5, the device 1000 may construct a neural network model 530 for providing an artificial intelligence service by combining the selected first neural network model 520-1 and second neural network model 520-2 in a parallel structure. However, the present disclosure is not limited thereto, and the device 1000 may construct a neural network model 530 for providing an artificial intelligence service by sequentially combining the first neural network model 520-1 and the second neural network model 520-2 in a cascade form.

FIG. 6 is a flowchart illustrating a method of registering a neural network model by a device 1000 according to one or more embodiments of the present disclosure.

Operations S610 and S620 illustrated in FIG. 6 may be performed before operation S410 illustrated in FIG. 4 is performed.

In operation S610, the device 1000 may obtain neural network model information about a plurality of neural network models stored in an external server or the memory 1200 (see FIG. 2) in the device 1000. In one or more embodiments, the device 1000 may include a communication interface for transmitting/receiving data to/from an external server or an external database by using a wired or wireless communication network. The communication interface may transmit/receive data to/from an external server or an external database by using, for example, at least one data communication network among wired LAN, wireless LAN, WiFi, Wireless Broadband Internet (WiBro), World Interoperability for Microwave Access (WiMAX), Shared Wireless Access Protocol (SWAP), Wireless Gigabit Alliance (WiGig), legacy network (e.g., 3G communication network or LTE), 5G communication network, and RF communication. The device 1000 may receive the neural network model information of the plurality of neural network models from an external server by using the communication interface. The external server may be a server operated by the same entity as the manufacturer of the device 1000; however, the present disclosure is not limited thereto and the external server may be a public server operated by other companies for common use purposes. A plurality of neural network models provided by the public server may be public models permitted to be used by several entities.

In another embodiment, the device 1000 may obtain neural network model information from a plurality of neural network models stored in the neural network model storage 1240 (see FIG. 2) in the memory 1200 (see FIG. 2). The neural network model information may be explicitly provided; however, the present disclosure is not limited thereto. In one or more embodiments, the neural network model information may be automatically generated.

FIG. 7 is a diagram illustrating neural network model information 700 obtained in the process of registering a neural network model by a device 1000 according to one or more embodiments of the present disclosure. Referring to FIG. 7 together with operation S610 of FIG. 6, the neural network model information 700 may include identification information 710, performance information 720, installation information 730, and evaluation information 740 of the neural network model.

The identification information 710 may include an identifier 711 of the neural network model and version information 712. The identifier 711 may be information for identifying the neural network model. The identifier 711 may be, for example, ID information of the neural network model. The version information 712 may refer to version information of a file constituting the neural network model. The version information 712 may include information about the date and time of the last update.

The performance information 720 may include a model feature 721, a model type 722, a use environment 723, a support system 724, an input format 725, a recognition object 726, a result format 727, accuracy 728, and latency 729 of the neural network model.

The model feature 721 may be information representing a feature for classifying the neural network model according to function and may include feature information representing the function of a neural network model such as an image recognition model, a voice recognition model, a sensor recognition model, or a custom model.

The model type 722 may include information representing the type of neural network model. The model type 722 may be, for example, any one of Efficientdet-B3, Efficientnet-B0, YOLO-v4, RefineDet, or M2Det; however, the present disclosure is not limited thereto.

The use environment 723 may include information representing the environment information in which the neural network model is trained. The use environment 723 may be, for example, a kitchen, a road, a school, a factory, or a park; however, the present disclosure is not limited thereto.

The support system 724 may include hardware resource information on which the neural network model may be executed. In one or more embodiments, the support system 724 may include information about the AI processor 1110 (see FIG. 3), the middleware 1230 (see FIG. 3), and the AI system driver 1250 (see FIG. 3). The support system 724 may include, for example, information about at least one of the operation and inference ability of the AI processor 1110, the version of the middleware 1230, and the version of the AI system driver 1250. However, the present disclosure is not limited thereto.

The input format 725 may be information about the format of input data input into the neural network model when inference is performed by using the neural network model. For example, when image data is applied as input data to the neural network model, the input format 725 may be JPEG 320×320, PCM signed 16 bit 2channel, or Exif. As another example, when voice data is applied as input data to the neural network model, the input format 725 may be way, mp3, Advanced Audio Codec (AAC), or ATRAC.

The recognition object 726 may include information about an object that may be recognized as a result of the inference by the neural network model. The recognition object 726 may be, for example, a human, a companion animal (e.g., a dog, a cat, or a rabbit), an obstacle, or a food material; however, the present disclosure is not limited thereto.

The result format 727 may include information for parsing the inference result by the neural network model. The result format 727 may include, for example, information about at least one of the recognition object, position, or confidence.

The accuracy 728 may include information about the accuracy of the inference results of the neural network model.

The latency 729 may include information about the time required to execute the neural network model. The latency 729 may vary depending on the information about the support system 724, i.e., the hardware resources of the device 1000. In one or more embodiments, the latency 729 may be updated according to the execution environment after execution of inference by the neural network model.

The installation information 730 may include information about a storage path 731 and a distribution method 732.

The storage path 731 may include information about the position at which the neural network model is stored. The storage path 731 may include, for example, identification information of the device 1000 in which the neural network model is stored or address information of a server (e.g., an IP address).

The distribution method 732 may include information about the entity or method of supplying the neural network model. The distribution method 732 may include, for example, provider information about whether the neural network model is an open public model or a model provided by a particular company.

The evaluation information 740 may include information about an evaluation result indicator according to the performance of the neural network model. The evaluation information 740 may include recommendation information 741 by the user or company using the neural network model. The recommendation information 741 may include rating information about the neural network model.

Referring back to FIG. 6, in operation S620, the device 1000 may register a plurality of neural network models by storing the obtained neural network model information. The device 1000 may store the obtained neural network model information in the memory 1200 (see FIG. 2). In one or more embodiments, the device 1000 may register a neural network model by storing neural network model information about a plurality of neural network models stored in the neural network model storage 1240 (see FIG. 2) in a partial area of the memory 1200 accessible to the middleware 1230 (see FIG. 2). Here, ‘registration’ may refer to an operation of providing the neural network model information to the middleware 1230 and storing the same in a partial area of the memory 1200 accessible to the middleware 1230.

FIG. 8A is a diagram illustrating a neural network model 810 constructed in a single structure by a device 1000 according to one or more embodiments of the present disclosure.

Referring to FIG. 8A, the device 1000 may use one neural network model 810 in a single structure. The device 1000 may obtain an intermediate output value 802 by applying input data 800 to the neural network model 810 in a single structure.

FIG. 8B is a diagram illustrating a neural network model 800b constructed by sequentially combining a plurality of neural network models 810 and 820 by a device 1000 according to one or more embodiments of the present disclosure.

Referring to FIG. 8B, the device 1000 may construct a neural network model 800b for providing an artificial intelligence service by sequentially combining a first neural network model 810 and a second neural network model 820. The neural network model 800b may be a model combined in a cascade form such that an output value of the first neural network model 810 is applied as input data of the second neural network model 820.

When the device 1000 applies input data 800 as input data to the neural network model 800b, the input data 800 may be input into the first neural network model 810 and the first neural network model 810 may output an intermediate output value 802 that is an inference result about the input data. The intermediate output value 802 may be applied as input data to the second neural network model 820, and a final output value 804 as the inference result by the second neural network model 820 may be obtained.

In one or more embodiments, the first neural network model 810 included in the neural network model 800b may be an object recognition model, and the second neural network model 820 may be an object recognition model trained to recognize an object corresponding to a subcategory of an object recognized by the first neural network model 810. For example, the first neural network model 810 may be a model trained to recognize a dog from image data, and the second neural network model 820 may be a model trained to recognize a dog's breed (e.g., retriever, poodle, bichon, shih tzu, or maltese). In the embodiment illustrated in FIG. 8B, when the input data 800 is image data including a dog, the intermediate output value 802 may include a label value representing a dog as a result of the inference by the first neural network model 810. When the intermediate output value 802 is input as input data to the second neural network model 820, a label value about the dog's breed may be obtained as the final output value 804 that is the inference result by the second neural network model 820.

FIG. 8C is a diagram illustrating a neural network model 800c constructed by combining a plurality of neural network models 810 and 820 in a parallel structure by a device 1000 according to one or more embodiments of the present disclosure.

Referring to FIG. 8C, the device 1000 may construct a neural network model 800c for providing an artificial intelligence service by combining a first neural network model 810 and a second neural network model 820 in a parallel structure.

When the device 1000 applies first input data 800-1 and second input data 800-2 as input data to the neural network model 800c, the first input data 800-1 may be input to the first neural network model 810 and the second input data 800-2 may be input to the second neural network model 820. A first output value 802-1 may be obtained according to the inference result by the first neural network model 810, and a second output value 802-2 may be obtained according to the inference result by the second neural network model 820.

In one or more embodiments, the neural network model 800c may be configured to sequentially perform inference by the first neural network model 810 and inference by the second neural network model 820 in order of time. For example, the device 1000 may first perform inference on the first input data 800-1 by using the first neural network model 810 and then perform inference on the second input data 800-2 by using the second neural network model 820. However, the present disclosure is not limited thereto, and the device 1000 may first perform inference by the second neural network model 820 and then perform inference by the first neural network model 810. Also, the device 1000 may simultaneously perform inference by the first neural network model 810 and inference by the second neural network model 820.

In one or more embodiments, the first neural network model 810 and the second neural network model 820 included in the neural network model 800c may be object recognition models that recognize different objects. For example, the first neural network model 810 may be a model trained to recognize a dog from image data, and the second neural network model 820 may be a model trained to recognize a cat from image data. In the embodiment illustrated in FIG. 8C, when the first input data 800-1 is image data including a dog, the first output value 802-1 may be a label value representing a dog as a result of the inference by the first neural network model 810. When the second input data 800-2 is image data including a cat, the second output value 802-2 may be a label value representing a cat as a result of the inference by the second neural network model 820.

FIG. 8D is a diagram illustrating a neural network model 800d constructed by combining a plurality of neural network models 810 and 820 in a parallel structure by a device 1000 according to one or more embodiments of the present disclosure.

Referring to FIG. 8D, the device 1000 may construct a neural network model 800d for providing an artificial intelligence service by combining a first neural network model 810 and a second neural network model 820 in a parallel structure.

The neural network model 800d may be configured to obtain a final output value 806 through an operation of adding the inference result value of the first neural network model 810 and the inference result value of the second neural network model 820. When the device 1000 applies input data 800 as input data to the neural network model 800d, the input data 800 may be input to the first neural network model 810 and the second neural network model 820 and a first intermediate output value 802-1 according to the inference result by the first neural network model 810 and a second intermediate output value 802-2 according to the inference result by the second neural network model 820 may be output. The neural network model 800d may obtain the final output value 806 through an operation of adding the first intermediate output value 802-1 and the second intermediate output value 802-2.

In one or more embodiments, the first neural network model 810 and the second neural network model 820 included in the neural network model 800d may be object recognition models that recognize different objects. In this case, the neural network model 800d may be a model for obtaining all of the first intermediate output value 802-1 according to the inference result of the first neural network model 810 and the second intermediate output value 802-1 according to the inference result of the second neural network model 820. For example, when the first neural network model 810 is a model trained to recognize a dog from image data and the second neural network model 820 is a model trained to recognize a cat from image data, the neural network model 800d may be a model for recognizing both a dog and a cat from image data.

FIG. 8E is a diagram illustrating a neural network model 800e constructed by combining a plurality of neural network models 810, 820, and 830 in a hybrid structure by a device 1000 according to one or more embodiments of the present disclosure.

Referring to FIG. 8E, the device 1000 may construct a neural network model 800e for providing an artificial intelligence service by combining a second neural network model 820 and a third neural network model 830 in a parallel structure and then combining the combined second neural network model 820 and third neural network model 830 with a first neural network model 810 in a hybrid structure by sequentially connecting the combined second neural network model 820 and third neural network model 830 to the first neural network model 810.

The neural network model 800e may be a model configured to obtain a final output value 808 by applying the inference result value of the first neural network model 810 as input data of the second neural network model 820 and the third neural network model 830 and adding the output value obtained as a result of the inference by the second neural network model 820 and the output value obtained as a result of the inference by the third neural network model 830. When the device 1000 applies input data 800 as input data to the neural network model 800e, the input data 800 may be input to the first neural network model 810 and an intermediate output value 802 according to the inference result by the first neural network model 810 may be output. The neural network model 800e may apply the intermediate output value 802 as input data to each of the second neural network model 820 and the third neural network model 830 and output a first intermediate output value 802-1 as a result of the inference through the second neural network model 820 and a second intermediate output value 802-2 as a result of the inference through the third neural network model 830. The neural network model 800e may obtain the final output value 808 through an operation of adding the first intermediate output value 802-1 and the second intermediate output value 802-2.

FIG. 9 is a flowchart illustrating a method of providing an artificial intelligence service by a device 1000 according to one or more embodiments of the present disclosure.

Operations S910, S920, and S930 illustrated in FIG. 9 may be detailed operations of operation S440 illustrated in FIG. 4. Operation S910 of FIG. 9 may be performed after operation S430 illustrated in FIG. 4 is performed.

In operation S910, the device 1000 may obtain image data by photographing the surrounding environment by using a camera. For example, when the device 1000 is a cleaning robot, the device 1000 may obtain image data about the indoor space by photographing the surrounding area by using a camera while traveling in the indoor space.

In operation S920, the device 1000 may recognize an object from the image data by applying the image data to the obtained neural network model. In one or more embodiments, the device 1000 may apply the image data as input data to the neural network model obtained in operation S430 and perform inference using the neural network model. The device 1000 may recognize an object from the image data according to the inference result. The neural network model may be, for example, an object recognition model such as Efficientdet-B3, Efficientnet-B0, YOLO-v4, RefineDet, or M2Det, and the device 1000 may use the neural network model to recognize a companion animal such as a dog or a cat as an object from the image data or to detect an obstacle present on the floor (e.g., wires, socks, toys, or mops lying on the floor).

In operation S930, the device 1000 may provide an artificial intelligence service related to the recognized object. In one or more embodiments, the device 1000 may use the recognized object to perform a function and/or operation according to the purpose of an artificial intelligence service. For example, when the purpose of an artificial intelligence service is pet care, the device 1000 may recognize a dog from the image data by using the neural network model and perform a behavior monitoring and management operation on the dog. As another example, when the purpose of an artificial intelligence service is cleaning by a cleaning robot, the device 1000 may detect an obstacle in the indoor space from the image data by using the neural network model and perform obstacle avoidance and a cleaning operation.

However, the neural network model of the present disclosure is not limited to an object recognition model. In one or more embodiments, the neural network model constructed according to the purpose of an artificial intelligence service may be a temperature control model of an air conditioner or may be an indoor air quality monitoring model. In this case, by using the neural network model, the device 1000 may provide an artificial intelligence service such as automatically controlling the set temperature of an air conditioner or monitoring the indoor air quality of an air cleaner.

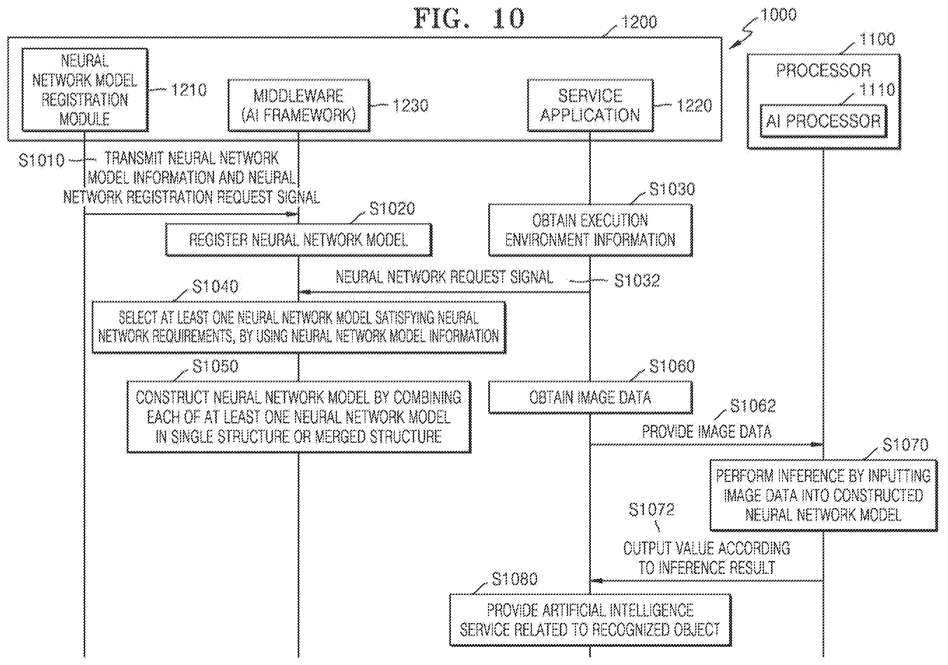

FIG. 10 is a flowchart illustrating operations between a plurality of components in a device 1000 according to one or more embodiments of the present disclosure.

Referring to FIG. 10, the device 1000 may include a processor 1100 and memory 1200. The processor 1100 may include an AI processor 1110, and the memory 1200 may include a neural network model registration module 1210, a service application 1220, and middleware 1230. The neural network model registration module 1210, the service application 1220, and the middleware 1230 may be respectively the same as the neural network model registration module 1210 (see FIG. 3), the service application 1220 (see FIG. 3), and the middleware 1230 (see FIG. 3) illustrated in FIG. 3, and thus, redundant descriptions thereof will be omitted for conciseness.

In operation S1010, the neural network model registration module 1210 may transmit neural network model information and a neural network registration request signal to the middleware 1230. The neural network model information may include identification information, performance information, installation information, and evaluation information about the plurality of neural network models. The neural network model registration module 1210 may provide neural network model information about a plurality of neural network models to the middleware 1230 and transmit a signal for requesting registration of the neural network model.

In operation S1020, the middleware 1230 may register the neural network model. In one or more embodiments, in response to the neural network registration request signal, the middleware 1230 may register the neural network model by storing the neural network model information obtained from the neural network model registration module 1210. Here, ‘registration’ may refer to an operation of storing the neural network model information in a partial area of the memory 1200 (see FIG. 2) accessible to the middleware 1230.

In operation S1030, the service application 1220 may obtain execution environment information of the device 1000. In one or more embodiments, the device 1000 may include a sensor, and the service application 1220 may control the device 1000 to obtain information related to the execution environment of the device 1000 by using the sensor of the device 1000. For example, the service application 1220 may use the sensor to obtain information about the position and time at which the device 1000 is executed. However, the present disclosure is not limited thereto, and the service application 1220 may control the device 1000 to obtain information about the illuminance, temperature, or humidity of the environment in which the device 1000 is being executed.

In operation S1032, the service application 1220 may transmit a neural network request signal to the middleware 1230. In one or more embodiments, the service application 1220 may transmit neural network requirements to the middleware 1230 together with the neural network request signal. The neural network requirements may be determined based on information about at least one of the execution environment of the device 1000, the purpose of an artificial intelligence service, and hardware resource feature of the device 1000.

In operation S1040, by using the neural network model information, the middleware 1230 may select at least one neural network model satisfying the neural network requirements.

In operation S1050, the middleware 1230 may construct a neural network model by combining at least one neural network model in a single structure or a merged structure. An operation of the middleware 1230 about operations S1040 and S1050 may be the same as the operation of the middleware 1230 (see FIG. 2) illustrated in FIG. 2, and thus, redundant descriptions thereof will be omitted for conciseness.

In operation S1060, the service application 1220 may obtain image data. In one or more embodiments, the device 1000 may include a camera, and the service application 1220 may obtain image data about the surrounding environment by photographing the surrounding environment by using the camera.

In operation S1062, the service application 1220 may provide the image data to the AI processor 1110.

The AI processor 1110 may be a dedicated hardware chip for performing multiplication and addition operations included in the neural network model. The AI processor 1110 may include, for example, a neural processing unit (NPU). However, the present disclosure is not limited thereto, and the AI processor 1110 may be configured as a portion of an existing general-purpose processor (e.g., a CPU or an application processor) or a graphic processor (e.g., a GPU).

In operation S1070, the AI processor 1110 may perform inference by inputting the image data into the constructed neural network model. In one or more embodiments, the AI processor 1110 may execute the neural network model constructed by the middleware 1230 and perform inference by applying the image data as input data to the neural network model.

The AI processor 1110 may obtain an output value according to the inference result. In one or more embodiments, the output value according to the inference result may be a label value about the type of an object recognized from the input data as a result of the inference using the neural network model.

In operation S1072, the AI processor 1110 may provide an output value according to the inference result. In one or more embodiments, the AI processor 1110 may provide a label value according to the inference result to the service application 1220, and the service application 1220 may recognize an object by identifying the label value output as a result of the inference by the neural network model.

In operation S1080, the service application 1220 may provide an artificial intelligence service related to the recognized object. By using the information about the object provided from the middleware 1230, the service application 1220 may perform a function and/or operation according to the purpose of an artificial intelligence service. Operation S1080 may be the same as operation S930 illustrated in FIG. 9, and thus, redundant descriptions thereof will be omitted for conciseness.

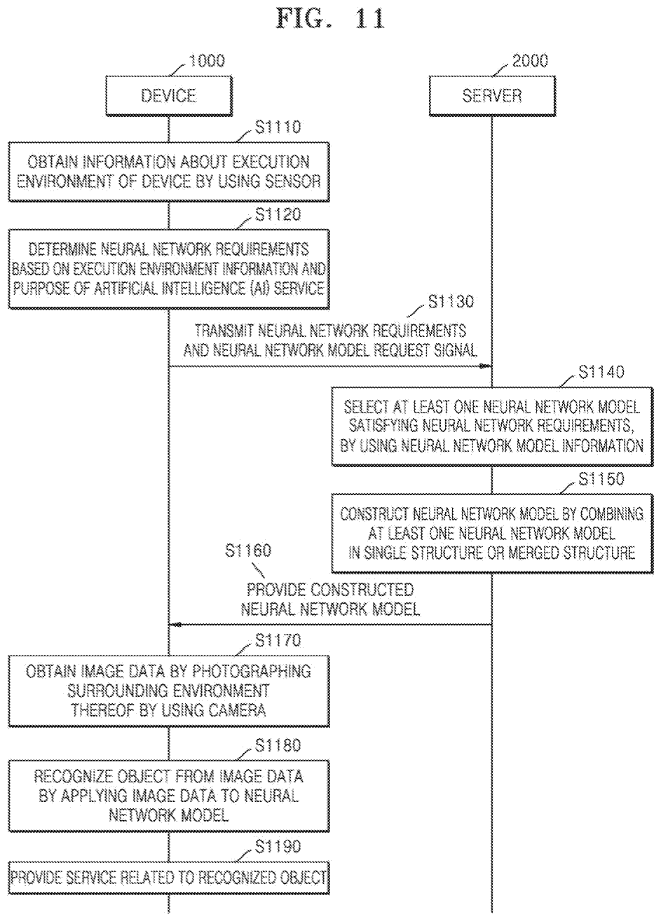

FIG. 11 is a flowchart illustrating operations of a device 1000 and a server 2000 according to one or more embodiments of the present disclosure.

In the embodiment illustrated in FIG. 11, the device 1000 may include a communication interface for transmitting/receiving data to/from the server 2000. The communication interface may transmit/receive data to/from the server 2000 by using, for example, at least one data communication network among wired LAN, wireless LAN, WiFi, Wireless Broadband Internet (WiBro), World Interoperability for Microwave Access (WiMAX), Shared Wireless Access Protocol (SWAP), Wireless Gigabit Alliance (WiGig), legacy network (e.g., 3G communication network or LTE), 5G communication network, and RF communication.

Unlike the embodiment illustrated in FIGS. 1 to 10, in the embodiment illustrated in FIG. 11, a plurality of neural network models and neural network model information may not be stored in the device 1000, and a plurality of neural network models may be registered and neural network model information may be stored in the server 2000.

In operation S1110, the device 1000 may obtain information about the execution environment of the device 1000 by using a sensor. In one or more embodiments, the device 1000 may include a sensor and may obtain information related to the execution environment of the device 1000 by using the sensor. For example, the device 1000 may use the sensor to obtain not only information about the position and time at which the device 1000 is being executed, but also information about illuminance, temperature, or humidity. In one or more embodiments, by using a communication interface, the device 1000 may obtain at least one of information obtained from the Internet through a wired or wireless network, syntax information related to a system operation, user information, and input information.

In operation S1120, the device 1000 may determine neural network requirements based on the execution environment information and the purpose of an artificial intelligence (AI) service. In one or more embodiments, the device 1000 may determine the neural network requirements based on the purpose of an artificial intelligence service provided by a service application being executed and the execution environment of the device 1000. In one or more embodiments, the purpose of the artificial intelligence service may be a recognition target object to be recognized by using a neural network model.

In another embodiment, the device 1000 may determine neural network requirements based on information about at least one of a recognition target object to be recognized according to the purpose of an artificial intelligence service, the execution environment of the device, and the hardware resource feature of the device 1000. The ‘hardware resource feature’ of the device 1000 may include hardware information about the operation and inference ability of the processor 1100 (see FIG. 2) and the capacity of the memory 1200 (see FIG. 2).

In operation S1130, by using the neural network model information, the server 2000 may select at least one neural network model satisfying the neural network requirements. Neural network model information of a plurality of neural network models may be stored in the server 2000. In one or more embodiments, the neural network model information may include identification information, performance information, installation information, and evaluation information about the plurality of neural network models. The server 2000 may select at least one neural network model among the plurality of neural network models stored in the memory (or database) of the server 2000, based on not only the execution environment information of the device 1000 and the purpose of the artificial intelligence service included in the neural network requirements but also the recognition accuracy and latency of the neural network model. In one or more embodiments, the server 2000 may select at least one neural network model satisfying a minimum reference value set for the recognition accuracy and a maximum latency set for the latency included in the neural network requirements.

In operation S1150, the server 2000 may construct a neural network model for providing an artificial intelligence service by combining at least one neural network model in a single structure or a merged structure. In one or more embodiments, the server 2000 may select only one neural network model, and in this case, a neural network model for providing an artificial intelligence service may be constructed in a single structure. In another embodiment, the server 2000 may select a plurality of neural network models and combine the plurality of selected neural network models in at least one of a parallel structure, a sequential structure, and a hybrid structure to construct a neural network model for providing an artificial intelligence service.

In operation S1160, the server 2000 may provide the constructed neural network model to the device 1000.

In operation S1170, the device 1000 may obtain image data by photographing the surrounding environment by using a camera.

In operation S1180, the device 1000 may recognize an object from the image data by applying the image data to the neural network model.

In operation S1190, the device 1000 may provide a service related to the recognized object. Operation S1170 to S1190 may be the same as operations S910 to S930 illustrated in FIG. 9, and thus, redundant descriptions thereof will be omitted for conciseness.

In order to solve the above technical problems, an aspect of the present disclosure provides a method of providing an artificial intelligence (AI) service by a device. The method may include identifying neural network requirements related to a purpose of the artificial intelligence service and an execution environment of the device. The method may include selecting at least one neural network model satisfying the neural network requirements, based on neural network model information about a plurality of preregistered neural network models. The method may include obtaining a neural network model for providing the artificial intelligence service, by using the selected at least one neural network model. The method may include providing the artificial intelligence service through the obtained neural network model.

In one or more embodiments of the present disclosure, the method may include obtaining the neural network model information about the plurality of neural network models stored in a memory in the device or in an external server, and registering the plurality of neural network models by storing the obtained neural network model information in the memory.

In one or more embodiments of the present disclosure, the neural network model information may include at least one of identification information, performance information, installation information, and evaluation information of each of the plurality of neural network models.

In one or more embodiments of the present disclosure, the identifying of the neural network requirements may include determining the neural network requirements based on a recognition target object to be recognized by using the neural network model, at a position and time at which the device provides the artificial intelligence service.

In one or more embodiments of the present disclosure, the identifying of the neural network requirements may include determining the neural network requirements based on at least one of execution environment information about the device, information about a recognition target object to be recognized according to the purpose of the artificial intelligence service, and hardware resource feature information about the device providing the artificial intelligence service.

In one or more embodiments of the present disclosure, the execution environment information may include at least one of information obtained by detecting an internal or external use environment of the device by using a sensor included in the device, information received from a server or an external device through a communication interface, syntax information related to a system operation, user information, and input information.

In one or more embodiments of the present disclosure, the selecting of the at least one neural network model may include selecting the at least one neural network model based on performance information including information about recognition accuracy and latency of each of the plurality of neural network models.

In one or more embodiments of the present disclosure, the method may further include downloading the plurality of neural network models from an external server or an external database and storing the plurality of downloaded neural network models in a memory of the device.

In one or more embodiments of the present disclosure, the selecting of the at least one neural network model may include selecting a plurality of neural network models satisfying the neural network requirements. The obtaining of the neural network model may include constructing a neural network model by combining the plurality of neural network models selected in any one of a sequential structure, a parallel structure, or a hybrid structure that is a combination of the sequential structure and the parallel structure.

In one or more embodiments of the present disclosure, the providing of the artificial intelligence service through the obtained neural network model may include obtaining image data by photographing a surrounding environment of the device by using a camera, and recognizing an object corresponding to the purpose of the artificial intelligence service, by applying the image data to the obtained neural network model.

In order to solve the above technical problems, another aspect of the present disclosure provides a device for providing an on-device artificial intelligence (AI) service. The device may include a memory storing at least one instruction, and at least one processor configured to execute the at least one instruction. The at least one processor may be configured to identify neural network requirements related to a purpose of the artificial intelligence service and an execution environment of the device. The at least one processor may be configured to select, based on neural network model information about a plurality of preregistered neural network models, at least one neural network model satisfying the neural network requirements among the plurality of neural network models. The at least one processor may be configured to obtain a neural network model for providing the artificial intelligence service, by using the selected at least one neural network model. The at least one processor may be configured to provide the artificial intelligence service through the obtained neural network model.

In one or more embodiments of the present disclosure, the device may further include a communication interface, wherein the at least one processor may be configured to obtain the neural network model information from an external server by using the communication interface or obtain the neural network model information from the plurality of neural network models stored in a neural network model storage in the device, and register the plurality of neural network models by storing the obtained neural network model information in the memory.

In one or more embodiments of the present disclosure, the neural network model information may include at least one of identification information, performance information, installation information, and evaluation information of each of the plurality of neural network models.

In one or more embodiments of the present disclosure, the at least one processor may be configured to determine the neural network requirements based on at least one of execution environment information about the device, information about a recognition target object to be recognized according to the purpose of the artificial intelligence service, and hardware resource feature information about the device providing the artificial intelligence service.

In one or more embodiments of the present disclosure, the device may further include a communication interface and a sensor configured to detect an internal or external use environment of the device, wherein the at least one processor may be configured to obtain execution environment information including at least one of information about the internal or external use environment of the device obtained by using the sensor, information received from a server or an external device through the communication interface, syntax information related to a system operation, user information, and input information.

In one or more embodiments of the present disclosure, the at least one processor may be configured to select the at least one neural network model based on performance information including information about recognition accuracy and latency of each of the plurality of neural network models.

In one or more embodiments of the present disclosure, the device may further include a communication interface, wherein the at least one processor may be configured to control the communication interface to download the plurality of neural network models from an external server or an external database, and store the plurality of downloaded neural network models in the memory.

In one or more embodiments of the present disclosure, the at least one processor may be configured to select a plurality of neural network models satisfying the neural network requirements, and construct the neural network model by combining the plurality of neural network models selected in any one of a sequential structure, a parallel structure, or a hybrid structure that is a combination of the sequential structure and the parallel structure.

In one or more embodiments of the present disclosure, the device may further include a camera, wherein the at least one processor may be configured to obtain image data by photographing a surrounding environment thereof by using the camera, and recognize an object corresponding to the purpose of the artificial intelligence service, by applying the image data to the obtained neural network model.

In order to solve the above technical problems, another aspect of the present disclosure provides a computer program product including a computer-readable storage medium having recorded therein a program to be executed in a computer. The computer-readable storage medium may include instructions for identifying neural network requirements related to a purpose of an artificial intelligence service and an execution environment of a device. The computer-readable storage medium may include instructions for selecting at least one neural network model satisfying the neural network requirements, based on neural network model information about a plurality of preregistered neural network models. The computer-readable storage medium may include instructions for obtaining a neural network model for providing the artificial intelligence service, by using the selected at least one neural network model. The computer-readable storage medium may include instructions for providing the artificial intelligence service through the obtained neural network model.

A program executed by the device 1000 described herein may be implemented as a hardware component, a software component, and/or a combination of a hardware component and a software component. The program may be performed by any system capable of executing computer-readable instructions.

The software may include computer programs, code, instructions, or a combination of one or more thereof and may configure the processor to operate as desired or may instruct the processor independently or collectively.

The software may be implemented as a computer program including instructions stored in a computer-readable storage medium. The computer-readable recording medium may include, for example, a magnetic storage medium (e.g., read-only memory (ROM), random-access memory (RAM), floppy disk, or hard disk) and an optical readable medium (e.g., CD-ROM or digital versatile disc (DVD)). The computer-readable recording medium may be distributed in network-connected computer systems such that computer-readable codes may be stored and executed in a distributed manner. The medium may be readable by a computer, stored in a memory, and executed in a processor.

The computer-readable storage medium may be provided in the form of a non-transitory storage medium. Here, “non-transitory” may merely mean that the storage medium does not include signals and is tangible, but does not distinguish semi-permanent or temporary storage of data in the storage medium. For example, the “non-transitory storage medium” may include a buffer in which data is temporarily stored.

Also, the program according to the embodiments described herein may be included and provided in a computer program product. The computer program product may be traded as a product between a seller and a buyer.

The computer program product may include a software program and a computer-readable storage medium with a software program stored therein. For example, the computer program product may include a product (e.g., a downloadable application) in the form of a software program electronically distributed through a manufacturer of an electronic device or an electronic market (e.g., Samsung Galaxy Store). For electronic distribution, at least a portion of the software program may be stored in a storage medium or may be temporarily generated. In this case, the storage medium may be a storage medium of a server of the manufacturer of the device 1000, a server of the electronic market, or a relay server for temporarily storing the software program.

The computer program product may include a storage medium of the server 2000 or a storage medium of the device 1000 in a system including the device 1000 and/or the server 2000 (see FIG. 11). Alternatively, when there is a third device (e.g., a mobile device) communicatively connected to the device 1000, the computer program product may include a storage medium of the third device. Alternatively, the computer program product may include the software program itself that is transmitted from the device 1000 to the third device or transmitted from the third device to the device 1000.

In this case, one of the device 1000, the server 2000, and the third device may execute the computer program product to perform the method according to the described embodiments. Alternatively, two or more of the device 1000, the server 2000, and the third device may execute the computer program product to perform the method according to the described embodiments in a distributed manner.

For example, the device 1000 may execute the computer program product stored in the memory 1200 (see FIG. 2) such that another electronic device (e.g., a mobile device) communicatively connected to the device 1000 may be controlled to perform the method according to the described embodiments.

As another example, the third device may execute the computer program product to control the electronic device communicatively connected to the third device to perform the method according to the described embodiments.

When the third device executes the computer program product, the third device may download the computer program product from the device 1000 and execute the downloaded computer program product. Alternatively, the third device may perform the method according to the described embodiments by executing the computer program product provided in a preloaded state.

While certain example embodiments the disclosure have been particularly shown and described, it will be understood that various changes in form and details may be made therein without departing from the spirit and scope of the following claims.

What is claimed is:

1. A method of providing, by a device, an artificial intelligence service, the method comprising:
identifying neural network requirements related to a purpose of the artificial intelligence service and an execution environment of the device;
selecting at least one neural network model satisfying the neural network requirements, based on neural network model information about a plurality of preregistered neural network models;
obtaining a neural network model for providing the artificial intelligence service, by using the selected at least one neural network model; and
providing the artificial intelligence service through the obtained neural network model.

2. The method of claim 1, further comprising:
obtaining the neural network model information about the plurality of preregistered neural network models stored in at least one memory in the device or in an external server; and
registering the plurality of preregistered neural network models by storing the neural network model information in the at least one memory.

3. The method of claim 1, wherein the identifying the neural network requirements comprises identifying the neural network requirements based on a recognition target object to be recognized by using the obtained neural network model, at a position and time at which the device provides the artificial intelligence service.

4. The method of claim 1, wherein the identifying the neural network requirements comprises identifying the neural network requirements based on at least one of execution environment information about the device, information about a recognition target object to be recognized according to the purpose of the artificial intelligence service, and hardware resource feature information about the device providing the artificial intelligence service.

5. The method of claim 1, wherein the selecting the at least one neural network model comprises selecting the at least one neural network model based on performance information comprising information about recognition accuracy and latency of each of the plurality of preregistered neural network models.

6. The method of claim 1, further comprising downloading the plurality of preregistered neural network models from an external server or an external database and storing the plurality of preregistered neural network models in at least one memory of the device.

7. The method of claim 1, wherein the providing the artificial intelligence service through the obtained neural network model comprises:
obtaining image data by photographing a surrounding environment of the device; and
recognizing an object corresponding to the purpose of the artificial intelligence service, by applying the image data to the obtained neural network model.

8. A device for providing an artificial intelligence service, the device comprising:
at least one memory storing at least one instruction; and
at least one processor configured to execute the at least one instruction to:
identify neural network requirements related to a purpose of the artificial intelligence service and an execution environment of the device;
select, based on neural network model information about a plurality of preregistered neural network models, at least one neural network model satisfying the neural network requirements among the plurality of preregistered neural network models;
obtain a neural network model for providing the artificial intelligence service, by using the selected at least one neural network model; and
provide the artificial intelligence service through the obtained neural network model.

9. The device of claim 8, further comprising a communication interface, wherein the at least one processor is further configured to execute the at least one instruction to:
obtain the neural network model information from an external server by using the communication interface or obtain the neural network model information from the plurality of preregistered neural network models stored in a neural network model storage in the device; and
register the plurality of preregistered neural network models by storing the obtained neural network model information in the at least one memory.

10. The device of claim 8, wherein the at least one processor is further configured to execute the at least one instruction to identify the neural network requirements based on at least one of execution environment information about the device, information about a recognition target object to be recognized according to the purpose of the artificial intelligence service, and hardware resource feature information about the device providing the artificial intelligence service.

11. The device of claim 8, wherein the at least one processor is further configured to execute the at least one instruction to select the at least one neural network model based on performance information comprising information about recognition accuracy and latency of each of the plurality of preregistered neural network models.

12. The device of claim 8, further comprising a communication interface, wherein the at least one processor is further configured to execute the at least one instruction to:
control the communication interface to download the plurality of preregistered neural network models from an external server or an external database, and
store the plurality of preregistered neural network models in the at least one memory.

13. The device of claim 8, wherein the at least one processor is further configured to execute the at least one instruction to:
select a plurality of neural network models satisfying the neural network requirements, and
construct the obtained neural network model by combining the selected plurality of neural network models in any one of a sequential structure, a parallel structure, or a hybrid structure that is a combination of the sequential structure and the parallel structure.

14. The device of claim 8, further comprising:
a camera,
wherein the at least one processor is further configured to execute the at least one instruction to:
obtain image data by photographing a surrounding environment thereof by using the camera, and
recognize an object corresponding to the purpose of the artificial intelligence service, by applying the image data to the obtained neural network model.

15. A computer program product comprising a non-transitory computer-readable storage medium, wherein the computer-readable storage medium comprises instructions for a method of providing, by a device, an artificial intelligence service, the method comprising:
identifying neural network requirements related to a purpose of the artificial intelligence service and an execution environment of the device;
selecting at least one neural network model satisfying the neural network requirements, based on neural network model information about a plurality of preregistered neural network models;
obtaining a neural network model for providing the artificial intelligence service, by using the selected at least one neural network model; and
providing the artificial intelligence service through the obtained neural network model.
